(19) United States
(12) Patent Application Publication
(10) Pub. No.: US 2026/0309891 A1
(43) Pub. Date: Oct. 8, 2026

(54) METHOD AND APPARATUS FOR PREDICTING DUAL-POROSITY STRUCTURE PARAMETERS OF DEEP COALBED METHANE RESERVOIR

(71) Applicant: CHINA UNIVERSITY OF MINING & TECHNOLOGY , BEIJING, Beijing (CN)

(72) Inventors: Fei Gong, Beijing (CN); Zhaoji Zhang, Beijing (CN); Suping Peng, Beijing (CN)

(21) Appl. No.: 19/444,078

(22) Filed: Jan. 8, 2026

(30) Foreign Application Priority Data
Mar. 27, 2025 (CN) 202510369896.9

(51) Int. Cl. G01V 11/00; E21B 49/00

(52) U.S. Cl. CPC G01V 11/002; E21B 49/00; E21B 2200/20

(57) ABSTRACT

The present disclosure provides a method and an apparatus for predicting dual-porosity structure parameters of a deep coalbed methane reservoir, which relates to the technical field of deep coalbed methane reservoir development, and solves the technical problem of low accuracy of prediction results of pores of deep coalbed methane reservoirs. The method includes: establishing a coalbed methane reservoir dual-porosity coal rock physics model using an equivalent medium theory model based on an initial organic matter content, a clay content, and a brittle mineral content; calculating a matrix porosity, a crack porosity, and a crack aspect ratio based on logging-observed P-wave velocity and S-wave velocity in the well logging data; and performing pre-stack seismic inversion to obtain prediction results of dual-porosity reservoir of the coalbed methane reservoir.

### CROSS-REFERENCE TO RELATED APPLICATIONS

This application is based upon and claims priority to Chinese Patent Application No. 202510369896.9, filed on Mar. 27, 2025, the entire contents of which are incorporated herein by reference.

### TECHNICAL FIELD

The present disclosure relates to the technical field of deep coalbed methane reservoir development, and particularly relates to a method and an apparatus for predicting dual-porosity structure parameters of a deep coalbed methane reservoir.

### BACKGROUND ART

At present, deep coalbed methane resources are abundant. The pore structure is a key parameter for predicting engineering sweet spots in deep coalbed methane reservoirs, serves as an important reference for evaluating dewatering and gas production of the deep coalbed methane, and has important significance for exploration and development of the deep coalbed methane reservoirs. However, the pore structure of a coalbed methane reservoir is complex, involving multiple pore types, and especially prediction of the pore structure of the deep coalbed methane reservoir presents certain difficulties. The coalbed methane reservoirs have complex pore structures, which can be mainly classified into a dual-porosity structure composed of cracks and matrix pores. At present, existing pore prediction methods for the coalbed methane reservoir are mainly derived from a single equivalent pore assumption but do not consider an influence of dual-porosity characteristics of the coalbed methane reservoir, resulting in relatively low accuracy of prediction results of pores of the coalbed methane reservoir in existing methods.

### SUMMARY

An objective of the present disclosure is to provide a method and an apparatus for predicting dual-porosity structure parameters of a deep coalbed methane reservoir, so as to solve a technical problem in which prediction results of pores of the deep coalbed methane reservoir are relatively low in accuracy.

In a first aspect, the present disclosure provides a method for predicting dual-porosity structure parameters of a deep coalbed methane reservoir driven by a rock physics model, including:
acquiring coal seam mineral data, regional sedimentary background data, and well logging data corresponding to the deep coalbed methane reservoir, and performing simplification processing on mineral components of the coalbed methane reservoir based on the coal seam mineral data and the regional sedimentary background data, to obtain organic matter data, clay data, and brittle mineral data;
determining an organic matter content using a resistivity-porosity overlay method based on the organic matter data, determining an initial clay content using a resistivity extremum method based on the clay data, and determining a remaining part except the initial clay content and the organic matter content in the mineral components of the coalbed methane reservoir as a brittle mineral content, wherein a resistivity corresponding to the resistivity extremum method and a porosity corresponding to the resistivity-porosity overlay method are determined through the well logging data;
establishing a coalbed methane reservoir dual-porosity coal rock physics model using an equivalent medium theory model based on the initial clay content, the organic matter content, and the brittle mineral content;
calculating a matrix porosity, a crack porosity, and a crack aspect ratio of a near-well coalbed methane reservoir based on logging-observed P-wave velocity and S-wave velocity in the well logging data, and taking the matrix porosity, the crack porosity, and the crack aspect ratio of the near-well coalbed methane reservoir as porosity parameter prior information of the deep coalbed methane reservoir dual-porosity coal rock physics model; and
performing pre-stack seismic Bayesian inversion using a pre-stack Bayesian inversion method through the deep coalbed methane reservoir dual-porosity coal rock physics model based on designated three-dimensional seismic horizon data and the porosity parameter prior information, to obtain dual-porosity structure data of the coalbed methane reservoir, and taking the dual-porosity structure data of the coalbed methane reservoir as a dual-porosity structure parameter prediction result of the coalbed methane reservoir.

In one possible implementation, the step of establishing the coalbed methane reservoir dual-porosity coal rock physics model using the equivalent medium theory model based on the initial clay content, the organic matter content, and the brittle mineral content includes:
performing mixing processing on organic matter, clay, and brittle minerals using a Voigt-Reuss-Hill bounds model based on the initial clay content, the organic matter content, and the brittle mineral content, to obtain elastic parameters of a coal matrix;
constructing dual-porosity characteristics of the deep coalbed methane reservoir, incorporating a dual porosity corresponding to the dual-porosity characteristics of the coalbed methane reservoir using a Kuster-Toksoz (KT) model based on the elastic parameters of the coal matrix, simulating a pore fluid bulk modulus under water saturation using an equal-stress averaging formula based on the dual-porosity characteristics of the coalbed methane reservoir after incorporating the dual porosity, and introducing fluid into a dry coal rock dry skeleton of the coalbed methane reservoir using a Gassmann equation to simulate an influence result of a pore fluid, to obtain an initial rock physics model; and
performing linearization processing on the initial rock physics model, to obtain the coalbed methane reservoir dual-porosity coal rock physics model.

In one possible implementation, the elastic parameters of the coal matrix are obtained through a following formula:

$$\{ \begin{matrix}{M}_{V} = {\sum }_{i = 1}^{N} {M}_{i} \cdot {V}_{i} \\ {M}_{R}^{- 1} = {\sum }_{i = 1}^{N} {M}_{i}^{- 1} \cdot {V}_{i} \\ {M}_{VRH} = \frac{1}{2} ( {M}_{R} + {M}_{V} )\end{matrix} ,$$

where Mᵢ is elastic modulus of an i-th brittle mineral, N is total number of the brittle minerals, Vᵢ(i=1, 2, . . . , N) is volume fraction of an i-th substance mineral, M_{VRH} is the elastic parameters of the coal matrix, and M_{V} and M_{R} are intermediate conversion parameters; and
a total pore volume of the coalbed methane reservoir corresponding to the dual-porosity characteristics of the deep coalbed methane reservoir includes following two types of pores: φₜₒₜₐₗ=φ_{stiff}+φ_{crack}, where φₜₒₜₐₗ is a total porosity, φ_{stiff} is a porosity of matrix pores, the matrix pores being pores randomly distributed in the coal matrix, and φ_{crack} is the crack porosity, where the crack porosity is randomly arranged.

The step of incorporating the dual porosity corresponding to the dual-porosity characteristics of the coalbed methane reservoir using the KT model includes incorporating the dual porosity into the dual-porosity characteristics of the coalbed methane reservoir using the KT model through a following formula:

$$\{ \begin{matrix}{K}_{KT} = \frac{( {K}_{m} + \frac{4}{3} {G}_{m} ) {K}_{m} + \frac{4}{3} {G}_{m} {{\sum }_{i = 1}}^{N} {f}_{i} ( {K}_{i} - {K}_{m} ) {P}^{mi}}{{K}_{m} + \frac{4}{3} {G}_{m} - {{\sum }_{i = 1}}^{N} {f}_{i} ( {K}_{i} - {K}_{m} ) {P}^{mi}} \\ {G}_{K T} = \frac{( {G}_{m} + {ζ}_{m} ) {G}_{m} + {{\sum }_{i = 1}}^{N} {f}_{i} ( {G}_{i} - {G}_{m} ) {Q}^{mi}}{{G}_{m} + {ζ}_{m} - {\sum }_{i = 1}^{N} {f}_{i} ( {G}_{i} - {G}_{m} ) {Q}^{mi}}\end{matrix} ,$$

$$wherein ζ = \frac{G}{6} \frac{9 K + 8 G}{K + 2 G} ,$$

where Kₘ and Gₘ are bulk modulus and shear modulus of a coal rock matrix, Ki is bulk modulus of an i-th type of pore, fᵢ is volume fraction containing pores, P^{mi} and Q^{mi} are parameters related to pore shape, K is bulk modulus, G is shear modulus, and N is a total number of pores.

The step of simulating the pore fluid bulk modulus under water saturation using a WOOD formula based on the dual-porosity characteristics of the coalbed methane reservoir after incorporating the dual porosity includes simulating the pore fluid bulk modulus under water saturation based on the dual-porosity characteristics of the coalbed methane reservoir after incorporating the dual porosity through a following formula:

$$\frac{1}{{K}_{fl}} = \frac{S w}{{K}_{w a t e r}} + \frac{1 - S w}{{K}_{g a s}} ,$$

where K_{fl} is an equivalent bulk modulus of the pore fluid, K_{water} is a liquid bulk modulus, K_{gas} is an air bulk modulus, and Sw is the water saturation.

The step of introducing the fluid into the dry coal rock dry skeleton of the coalbed methane reservoir using the Gassmann equation includes introducing the fluid into the dry coal rock dry skeleton of the coalbed methane reservoir through a following equation:

$${K}_{sat} = \frac{( {ϕ}_{1} + {ϕ}_{2} ) ( \frac{1}{{K}_{0}} - \frac{1}{{K}_{fl}} ) + \frac{1}{{K}_{0}} - \frac{1}{{K}_{dry}}}{( {ϕ}_{1} + {ϕ}_{2} ) ( \frac{1}{{K}_{0}} - \frac{1}{{K}_{fl}} ) \frac{1}{{K}_{d}} + ( \frac{1}{{K}_{0}} - \frac{1}{{K}_{dry}} ) \frac{1}{{K}_{0}^{2}}} ,$$

where φ₁ and φ₂ are porosities of matrix pores and cracks respectively, K₀ is a bulk modulus of rock minerals, K_{dry} is bulk modulus of a dry rock skeleton, K_{fl} is a fluid bulk modulus, and K_{d} is a bulk modulus of dry coal rock skeleton.

A forward relation formula of the deep coalbed methane reservoir dual-porosity coal rock physics model is:

$$m \approx f ( x ) + e ,$$

where x is rock physics parameters to be inverted, e is random error, m is elastic parameters, f(⋅) is a corresponding relationship of the rock physics model. Performing first-order Taylor approximation on the forward relation formula at a point x₀ yields:

$$m \approx f ( {x}_{0} ) + D ( x - {x}_{0} ) ,$$

where D is a linear forward operator of the rock physics model, x is the rock physics parameters to be inverted, m is the elastic parameters, f(⋅) is the corresponding relationship of the rock physics model, and x₀ is a point selected at different independent variables.

In one possible implementation, the step of calculating the matrix porosity and the crack aspect ratio of the near-well coalbed methane reservoir based on the logging-observed P-wave velocity and the logging-observed S-wave velocity in the well logging data includes:
solving inversion data using a Bayesian theoretical model, to obtain posterior probability of target parameters with respect to observed data;
determining prior information of a mixed Gaussian distribution using a Gaussian mixture model to describe a prior distribution of physical properties;
determining a probability distribution function based on the posterior probability and the prior information; and
calculating the matrix porosity and the crack aspect ratio of the near-well coalbed methane reservoir through the probability distribution function based on the logging-observed P-wave velocity and the logging-observed S-wave velocity in the well logging data, to obtain a constructed inversion objective function.

In one possible implementation, the posterior probability of the target parameters with respect to the observed data is:

$$P ( r \vert m ) ∝ P ( m \vert r ) \times P ( r ) ,$$

where P(r|m) is the posterior probability, P(m|r) is a likelihood probability, and P(r) is a prior probability;
the prior information is:

$$P ( r ) = {\sum }_{k = 1}^{C} {φ}_{k} {N}_{k} ( r ; {μ}_{r}^{k} , {\sum }_{r}^{k} ) ,$$

where P(r) is the prior probability, Nₖ is a k-th Gaussian distribution,

$${μ}_{r}^{k}$$

is an expectation value of the k-th Gaussian distribution,

$${\sum }_{r}^{k}$$

is a covariance of the k-th Gaussian distribution, φₖ is a weight coefficient of the k-th Gaussian distribution, C is a total number of Gaussian distributions, and r represents the prior; and
the inversion objective function is:

$$J ( asp ) = {‖ {Vp}_{estimated} - {Vp}_{real} ‖}_{2}^{2} + {‖ {Vs}_{estimated} - {Vs}_{real} ‖}_{2}^{2} ,$$

where asp is a reservoir crack aspect ratio, and Vpᵣₑₐₗ are Vsᵣₑₐₗ the logging-observed P-wave velocity and the logging-observed S-wave velocity in the well logging data; and Vp_{estimated} and Vs_{estimated} are a model-predicted P-wave velocity and a model-predicted S-wave velocity, respectively.

In one possible implementation, the step of performing the pre-stack seismic Bayesian inversion using the pre-stack Bayesian inversion method through the deep coalbed methane reservoir dual-porosity coal rock physics model based on the designated three-dimensional seismic horizon data and the porosity parameter prior information, to obtain the dual-porosity structure data of the coalbed methane reservoir, and taking the dual-porosity structure data of the coalbed methane reservoir as the dual-porosity structure parameter prediction result of the coalbed methane reservoir, includes:
extracting a pre-stack seismic angle gather based on the designated three-dimensional seismic horizon data to obtain a relationship between reflection-wave time and amplitude under different incident angles at each point;
extracting time information of a reflection wave of a target coal seam at each point based on the well logging data and seismic data corresponding to the designated three-dimensional seismic horizon data, and applying a time window along the coal seam to extract reflection-wave information of the target coal seam;
obtaining coal component information and water saturation information through interpolation results of the well logging data;
constructing a Bayesian inversion objective function of the seismic data based on the time information, the reflection-wave information, the coal component information, the water saturation information, and the relationship between the reflection-wave time and the amplitude;
substituting data of the same angle gather into the Bayesian inversion objective function to perform inversion, to obtain dual-porosity rock physics parameters of the coalbed methane reservoir at a spatial position, and taking the dual-porosity rock physics parameters of the coalbed methane reservoir as the dual-porosity structure data of the coalbed methane reservoir dual-porosity structure data.

In one possible implementation, the Bayesian inversion objective function is:

$$m = arg min {\sum }_{i = 1}^{n} {k}_{i} ( {‖ d - {f ( m )}^{*} w ‖}_{2} + {( m - {μ}_{m}^{i} )}^{T} {( {Ω}_{m}^{i} )}^{- 1} ( m - {μ}_{m}^{i} ) ) ,$$

wherein kᵢ is a weight factor of an i-th Gaussian distribution, d is the seismic data, m is inversion parameters, f is a mapping relationship, μₘ is an expectation, Ωₘ is a covariance matrix, and w is a seismic wavelet.

In a second aspect, the present disclosure provides an apparatus for predicting dual-porosity structure parameters of a deep coalbed methane reservoir driven by a rock physics model, including:
an acquisition module, configured to acquire coal seam mineral data, regional sedimentary background data, and well logging data corresponding to the deep coalbed methane reservoir, and perform simplification processing on mineral components of the coalbed methane reservoir based on the coal seam mineral data and the regional sedimentary background data, to obtain organic matter data, clay data, and brittle mineral data;
a determination module, configured to determine an initial clay content using a resistivity extremum method based on the clay data, determine an organic matter content using a resistivity-porosity overlay method based on the organic matter data, and determine a remaining part except the initial clay content and the organic matter content in the mineral components of the coalbed methane reservoir as a brittle mineral content, wherein a resistivity corresponding to the resistivity extremum method and a porosity corresponding to the resistivity-porosity overlay method are determined through the well logging data;
an establishment module, configured to establish a deep coalbed methane reservoir dual-porosity coal rock physics model using an equivalent medium theory model based on the initial clay content, the organic matter content, and the brittle mineral content;
a calculation module, configured to calculate a matrix porosity, a crack porosity, and a crack aspect ratio of a near-well coalbed methane reservoir based on logging-observed P-wave velocity and S-wave velocity in the well logging data, and take the matrix porosity, the crack porosity, and the crack aspect ratio of the near-well coalbed methane reservoir as porosity parameter prior information of the deep coalbed methane reservoir dual-porosity coal rock physics model; and
an inversion module, configured to perform pre-stack seismic Bayesian inversion using a pre-stack Bayesian inversion method through the deep coalbed methane reservoir dual-porosity coal rock physics model based on designated three-dimensional seismic horizon data and the porosity parameter prior information, to obtain dual-porosity structure data of the coalbed methane reservoir, and take the dual-porosity structure data of the coalbed methane reservoir as a dual-porosity structure parameter prediction result of the coalbed methane reservoir.

In a third aspect, the present disclosure further provides an electronic device, including a memory and a processor, wherein the memory stores a computer program executable on the processor, and the processor, when executing the computer program, implements the method in the first aspect.

In a fourth aspect, the present disclosure further provides a computer-readable storage medium, wherein the computer-readable storage medium stores computer-executable instructions, and when the computer-executable instructions are invoked and executed by a processor, the computer-executable instructions cause the processor to run the method in the first aspect.

The present disclosure has the following beneficial effects.

The present disclosure provides a method and an apparatus for predicting dual-porosity structure parameters of a deep coalbed methane reservoir, which are capable of acquiring coal seam mineral data, regional sedimentary background data, and well logging data corresponding to the deep coalbed methane reservoir, and performing simplification processing on mineral components of the coalbed methane reservoir based on the coal seam mineral data and the regional sedimentary background data, to obtain organic matter data, clay data, and brittle mineral data; determining the initial clay content using the resistivity extremum method based on the clay data, determining the organic matter content using the resistivity-porosity overlay method based on the organic matter data, and determining the remaining part except the initial clay content and the organic matter content in the mineral components of the coalbed methane reservoir as the brittle mineral content, wherein the resistivity corresponding to the resistivity extremum method and the porosity corresponding to the resistivity-porosity overlay method are determined through the well logging data; establishing the coalbed methane reservoir dual-porosity coal rock physics model using the equivalent medium theory model based on the initial clay content, the organic matter content, and the brittle mineral content; calculating the matrix porosity, the crack porosity, and the crack aspect ratio of the near-well coalbed methane reservoir based on the logging-observed P-wave velocity and S-wave velocity in the well logging data, and taking the matrix porosity, the crack porosity, and the crack aspect ratio of the near-well coalbed methane reservoir as porosity parameter prior information of the deep coalbed methane reservoir dual-porosity coal rock physics model; and performing pre-stack seismic Bayesian inversion processing using the pre-stack Bayesian inversion method through the deep coalbed methane reservoir dual-porosity coal rock physics model based on designated three-dimensional seismic horizon data and the porosity parameter prior information, to obtain the dual-porosity structure data of the coalbed methane reservoir, and take the dual-porosity structure data of the coalbed methane reservoir as the dual-porosity structure parameter prediction result of the coalbed methane reservoir. In the present solution, on the basis of pore structure characteristics of coal rock of the coalbed methane reservoir, a dual-porosity coalbed methane reservoir rock physics model is established. Prior information for Bayesian inversion is determined in combination with the well logging data, and dual-porosity structure parameters of the coalbed methane reservoir are further inverted by combining pre-stack seismic data. This enables full integration of the actual geological characteristics of the coalbed methane reservoir rock and enables in-depth reconstruction of the pore structure characteristics of the coalbed methane reservoir. A complete elastic matrix is obtained in combination with well logging and seismic data, thereby obtaining accurate dual-porosity structure characteristics of the coalbed methane reservoir. The rock physics model is constructed based on material composition and the pore structure characteristics of the coalbed methane reservoir, and linearization is performed by applying a Taylor series. This improves inversion efficiency, satisfies reservoir prediction analysis using conventional well logging and seismic data, enables prediction of the dual-porosity structure parameters of the coalbed methane reservoir, and further improves the prediction accuracy of the coalbed methane reservoir.

In order to make the above objectives, features, and advantages of the present disclosure more obvious and easier to understand, detailed description is given below particularly with preferred embodiments, together with the attached drawings.

### BRIEF DESCRIPTION OF DRAWINGS

In order to more clearly illustrate technical solutions of embodiments of the present disclosure or the prior art, the drawings required to be used in the description of the embodiments or the prior art will be briefly introduced as follows. Obviously, the drawings described below are for some embodiments of the present disclosure. Those of ordinary skill in the art, without making inventive efforts, could also obtain other drawings according to these drawings.

FIG. 1 is a schematic flowchart of a method for predicting dual-porosity structure parameters of a deep coalbed methane reservoir driven by a rock physics model provided by an embodiment of the present disclosure;

FIG. 2 is a schematic flow diagram of dual-porosity rock physics model modeling of a deep coalbed methane reservoir provided by an embodiment of the present disclosure;

FIG. 3 is a schematic diagram of linearization results of a deep coalbed methane reservoir corresponding to crack density provided by an embodiment of the present disclosure;

FIG. 4 is another schematic diagram of linearization results of the deep coalbed methane reservoir corresponding to crack porosity provided by an embodiment of the present disclosure;

FIG. 5 is a schematic diagram of linearization results of the deep coalbed methane reservoir corresponding to pore porosity provided by an embodiment of the present disclosure;

FIG. 6 is another schematic diagram of linearization results of the deep coalbed methane reservoir corresponding to pore porosity provided by an embodiment of the present disclosure;

FIG. 7 is a schematic diagram of linearization results of the deep coalbed methane reservoir corresponding to model asp provided by an embodiment of the present disclosure;

FIG. 8 is another schematic diagram of linearization results of the deep coalbed methane reservoir corresponding to model asp provided by an embodiment of the present disclosure;

FIG. 9 is a Gaussian mixture distribution inversion diagram of well logging data provided by an embodiment of the present disclosure;

FIG. 10 is another schematic flowchart of a method for predicting dual-porosity structure parameters of a deep coalbed methane reservoir driven by a rock physics model provided by an embodiment of the present disclosure;

FIG. 11 is a schematic diagram of matrix porosity in reservoir dual-porosity structure prediction effect;

FIG. 12 is a schematic diagram of crack density in reservoir dual-porosity structure prediction effect;

FIG. 13 is a schematic diagram of crack aspect ratio in reservoir dual-porosity structure prediction effect;

FIG. 14 is a schematic structural diagram of an apparatus for predicting dual-porosity structure parameters of a deep coalbed methane reservoir driven by a rock physics model provided by an embodiment of the present disclosure; and

FIG. 15 illustrates a structural schematic diagram of an electronic device provided by an embodiment of the present disclosure.

### DETAILED DESCRIPTION OF EMBODIMENTS

In order to make the objectives, technical solutions, and advantages of the embodiments of the present disclosure clearer, the following description will provide a clear and comprehensive explanation of the technical solutions in the present disclosure with reference to the drawings. Obviously, the described embodiments are some of the embodiments of the present disclosure and not all embodiments. Based on the embodiments in the present disclosure, all other embodiments obtained by those of ordinary skill in the art without making inventive efforts are within the scope of protection of the present disclosure.

In the embodiments of the present disclosure, the terms “include,” “comprise,” and any variations thereof, are intended to cover a non-exclusive inclusion. For example, a process, method, system, product or device including a series of steps or units is not limited to the listed steps or units, but may optionally include unlisted steps or units, or may optionally further include other steps or units inherent to the process, method, product or apparatus.

In the prior art, for the problem of lack of a systematic evaluation method for supercritical CO₂ fracability of a deep coalbed methane reservoir, geological factors and mechanical characteristics of the coalbed methane reservoir can be adopted to analyze occurrence characteristics and influencing factors of the coalbed methane reservoir, thus establishing a supercritical CO₂ fracability evaluation system for the deep coalbed methane reservoir. In addition, brittle characterization can also be performed by multiple brittleness representation methods at present. A Xu-White model is selected to perform rock physics modeling on a target seam and to supplement well logging data. However, dual-porosity structure characteristics of the coalbed methane reservoir have certain difference from the Xu-White model. A method for predicting the dual-porosity structure of the coalbed methane reservoir is still lacking. At present, evaluation systems for dual-porosity characteristics of the coalbed methane reservoir are not complete, and existing methods have relatively low accuracy of prediction results of pores of the coalbed methane reservoir.

Based on this, the embodiments of the present disclosure provide a method and an apparatus for predicting dual-porosity structure parameters of a deep coalbed methane reservoir, and by the method, a technical problem of relatively low accuracy of prediction results of pores of the deep coalbed methane reservoir can be solved.

Below, embodiments of the present disclosure are further described in combination with the drawings.

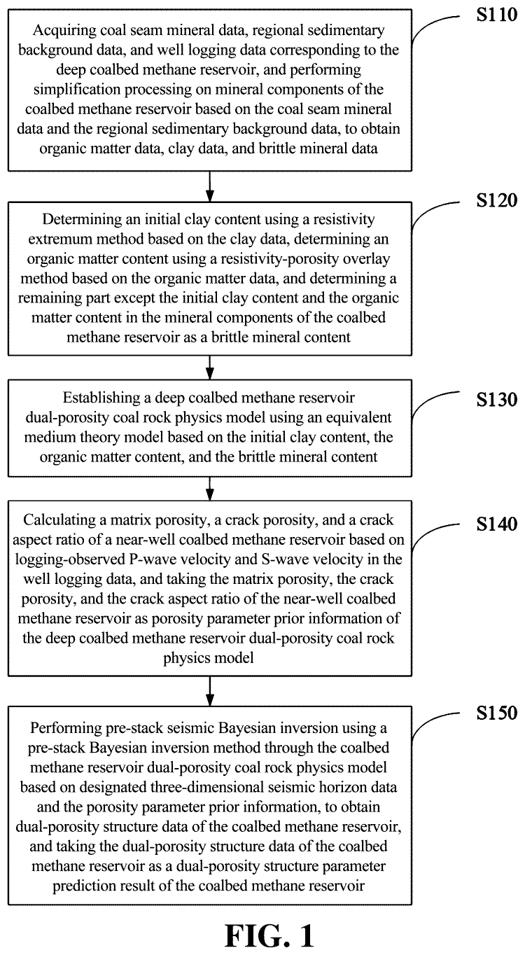

FIG. 1 is a schematic flowchart of a method for predicting dual-porosity structure parameters of a deep coalbed methane reservoir driven by a rock physics model provided by an embodiment of the present disclosure. As shown in FIG. 1, the method includes following steps.

Step S110: acquiring coal seam mineral data, regional sedimentary background data, and well logging data corresponding to the deep coalbed methane reservoir, and performing simplification processing on mineral components of the coalbed methane reservoir based on the coal seam mineral data and the regional sedimentary background data, to obtain organic matter data, clay data, and brittle mineral data.

As one possible embodiment, based on data related to deep coal seam minerals and the regional sedimentary background, the mineral components of the deep coalbed methane reservoir are simplified and are simplified into organic matter, clay, and brittle minerals.

Step S120: determining an initial clay content using a resistivity extremum method based on the clay data, determining an organic matter content using a resistivity-porosity overlay method based on the organic matter data, and determining a remaining part except the initial clay content and the organic matter content in the mineral components of the coalbed methane reservoir as a brittle mineral content.

Herein, a resistivity corresponding to the resistivity extremum method and a porosity corresponding to the resistivity-porosity overlay method are determined through the well logging data. Exemplarily, the resistivity extremum method is used to obtain the initial clay content, and the resistivity-porosity overlay method is used to obtain the organic matter content, wherein the resistivity and porosity are derived from the well logging data. The remaining part is regarded as brittle minerals.

Step S130: establishing a deep coalbed methane reservoir dual-porosity coal rock physics model using an equivalent medium theory model based on the initial clay content, the organic matter content, and the brittle mineral content.

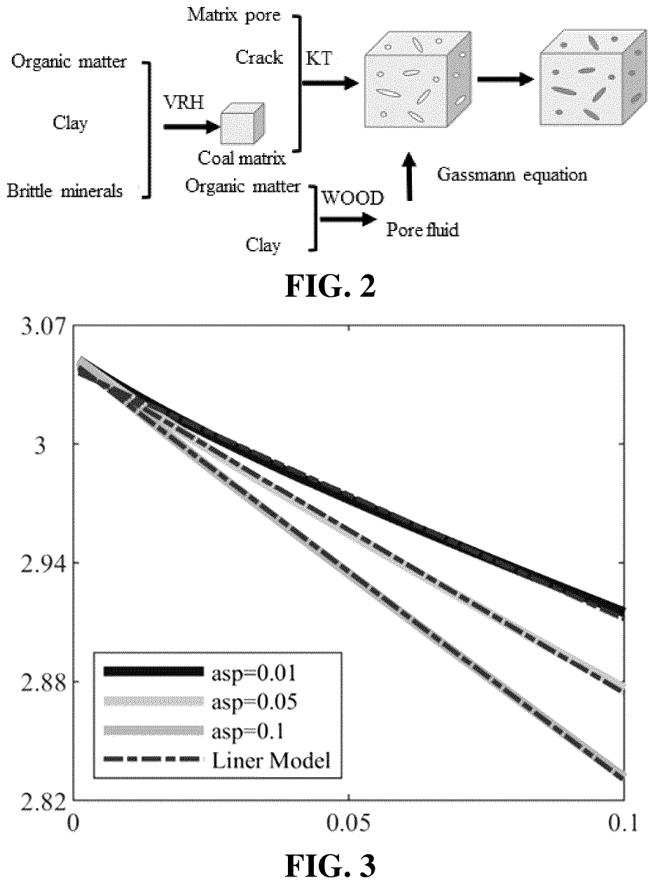

In an optional embodiment, as shown in FIG. 2, the coalbed methane reservoir has dual-porosity characteristics, and dual-porosity coal rock physics modeling of the coalbed methane reservoir is performed based on the equivalent medium theory according to FIG. 2, thus obtaining the dual-porosity coal rock physics model of the coalbed methane reservoir. As an example, step S130 can specifically include following steps:
performing mixing processing on the organic matter, clay, and brittle minerals using a Voigt-Reuss-Hill bounds model based on the initial clay content, the organic matter content, and the brittle mineral content, to obtain elastic parameters of a coal matrix;
constructing dual-porosity characteristics of the coalbed methane reservoir, incorporating a dual porosity corresponding to the dual-porosity characteristics of the coalbed methane reservoir using a KT model based on the elastic parameters of the coal matrix, simulating a pore fluid bulk modulus under water saturation using an equal-stress averaging formula based on the dual-porosity characteristics of the coalbed methane reservoir after incorporating the dual porosity, and introducing fluid into a dry coal rock dry skeleton of the coalbed methane reservoir using a Gassmann equation to simulate an influence result of a pore fluid, to obtain an initial rock physics model; and
performing linearization processing on the initial rock physics model, to obtain the coalbed methane reservoir dual-porosity coal rock physics model.

As an optional embodiment, Voigt-Reuss-Hill bounds theory is first adopted to mix the organic matter, clay, and brittle minerals to obtain the elastic parameters of the coal matrix. The elastic parameters of the coal matrix are obtained through the following formula:

$$\{ \begin{matrix}{M}_{V} = {\sum }_{i = 1}^{N} {M}_{i} \cdot {V}_{i} \\ {M}_{R}^{- 1} = {\sum }_{i = 1}^{N} {M}_{i}^{- 1} \cdot {V}_{i} \\ {M}_{VRH} = \frac{1}{2} ( {M}_{R} + {M}_{V} )\end{matrix} , \qquad ( 1 )$$

where Mᵢ is elastic modulus of an i-th brittle mineral, N is total number of brittle minerals, Vᵢ(i=1, 2, . . . , N) is volume fraction of an i-th substance mineral (where three components exist: organic matter, clay, and brittle minerals), M_{VRH} is the elastic parameters of the coal matrix, and M_{V} and M_{R} are intermediate conversion parameters.

Then dual-porosity characteristics of the coalbed methane reservoir are constructed. The KT model is employed to incorporate the dual porosity into the elastic parameters of the coal matrix obtained after mixing the organic matter, clay, and brittle minerals. A total pore volume of the coalbed methane reservoir corresponding to the dual-porosity characteristics of the coalbed methane reservoir includes following two types of pores: φₜₒₜₐₗ=φ_{stiff}+φ_{crack} (2), where φₜₒₜₐₗ is a total porosity, φ_{stiff} is a porosity of matrix pores, where the matrix pores are pores randomly distributed in the coal matrix, and φ_{crack} is crack porosity, where the crack porosity is randomly arranged.

Afterwards, the step of incorporating the dual porosity into the dual-porosity characteristics of the coalbed methane reservoir using the KT model includes incorporating the dual porosity into the dual-porosity characteristics of the coalbed methane reservoir using the KT model through the following formula. That is, the KT model is employed to incorporate matrix pores and cracks having a certain aspect ratio. It is assumed herein that matrix particle media are circular and the aspect ratio equals 1. The crack aspect ratio is unknown and needs to be obtained through inversion:

$$\{ \begin{matrix}{K}_{KT} = \frac{( {K}_{m} + \frac{4}{3} {G}_{m} ) {K}_{m} + \frac{4}{3} {G}_{m} {\sum }_{i = 1}^{N} {f}_{i} ( {K}_{i} - {K}_{m} ) {P}^{mi}}{{K}_{m} + \frac{4}{3} {G}_{m} - {\sum }_{i = 1}^{N} {f}_{i} ( {K}_{i} - {K}_{m} ) {P}^{mi}} \\ {G}_{KT} = \frac{( {G}_{m} + {ζ}_{m} ) {G}_{m} + {\sum }_{i = 1}^{N} {f}_{i} ( {G}_{i} - {G}_{m} ) {Q}^{mi}}{{G}_{m} + {ζ}_{m} - {\sum }_{i = 1}^{N} {f}_{i} ( {G}_{i} - {G}_{m} ) {Q}^{mi}}\end{matrix} , \qquad ( 3 )$$

$$where$$

$$ζ = \frac{G}{6} \frac{9 K + 8 G}{K + 2 G} , \qquad ( 4 )$$

where Kₘ and Gₘ are bulk modulus and shear modulus of a coal rock matrix, Ki is bulk modulus of an i-th type of pore, fᵢ is volume fraction containing pores (two types in total, namely, matrix pores and cracks), P^{mi} and Q^{mi} are parameters related to pore shape, K is bulk modulus, G is shear modulus, and Nis a total number of pores.

Then, the equal-stress averaging formula (WOOD formula) is employed to simulate the pore fluid bulk modulus under certain water saturation. For example, the step of simulating the pore fluid bulk modulus under water saturation using the WOOD formula based on the dual-porosity characteristics of the coalbed methane reservoir after incorporating the dual porosity includes simulating the pore fluid bulk modulus under water saturation based on the dual-porosity characteristics of the coalbed methane reservoir after incorporating the dual porosity through a following formula:

$$\frac{1}{{K}_{fl}} = \frac{S w}{{K}_{water}} + \frac{1 - S w}{{K}_{gas}} , \qquad ( 5 )$$

where K_{fl} is an equivalent bulk modulus of pore fluid, K_{water} is a liquid bulk modulus (which can be equivalent to water, taken as 2.2 GPa), K_{gas} is an air bulk modulus (which can be equivalent to air, taken as 0.14 MPa), and Sw is the water saturation.

Afterwards, to simulate the effect of the pore fluid, the fluid is introduced into the dry coal rock dry skeleton using the Gassmann equation. Introducing the fluid into the dry coal rock dry skeleton of the coalbed methane reservoir using the Gassmann equation includes introducing the fluid into the dry coal rock dry skeleton of the coalbed methane reservoir through a following formula:

$${K}_{sat} = \frac{( {ϕ}_{1} + {ϕ}_{2} ) ( \frac{1}{{K}_{0}} - \frac{1}{{K}_{fl}} ) + \frac{1}{{K}_{0}} - \frac{1}{{K}_{dry}}}{( {ϕ}_{1} + {ϕ}_{2} ) ( \frac{1}{{K}_{0}} - \frac{1}{{K}_{fl}} ) \frac{1}{{K}_{d}} + ( \frac{1}{{K}_{0}} - \frac{1}{{K}_{dry}} ) \frac{1}{{K}_{0}^{2}}} , \qquad ( 6 )$$

where φ₁ and φ₂ are porosities of matrix pores and cracks respectively, K₀ is a bulk modulus of rock minerals, K_{dry} is bulk modulus of a dry rock skeleton, K_{fl} is a fluid bulk modulus, and K_{d} is a bulk modulus of a dry coal rock skeleton.

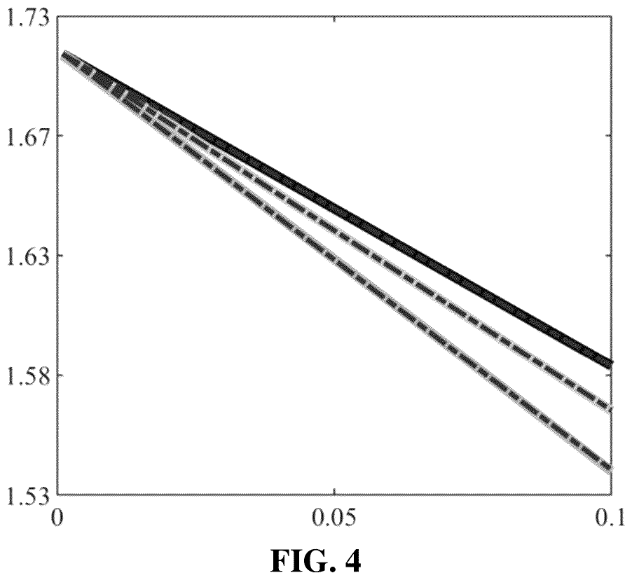

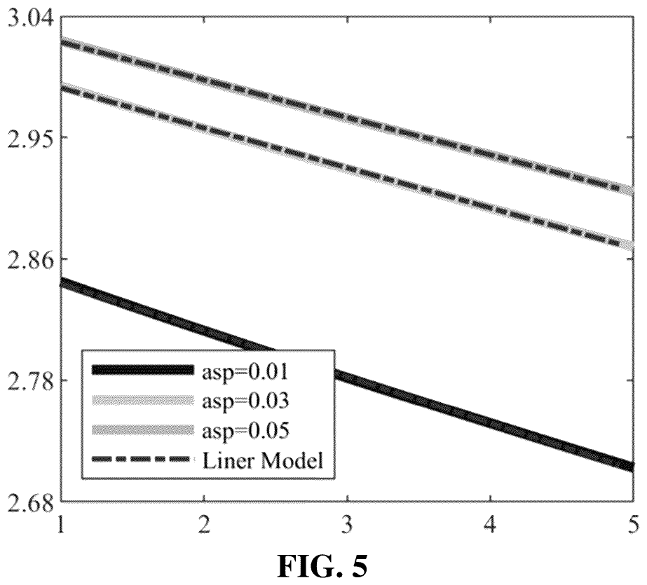

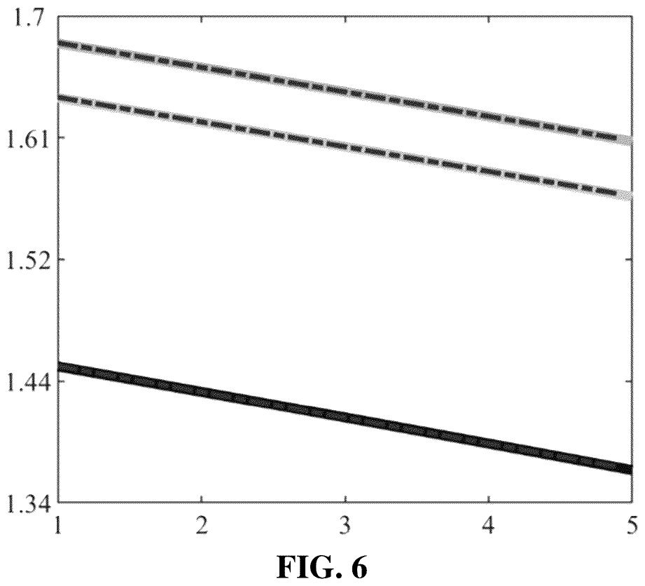

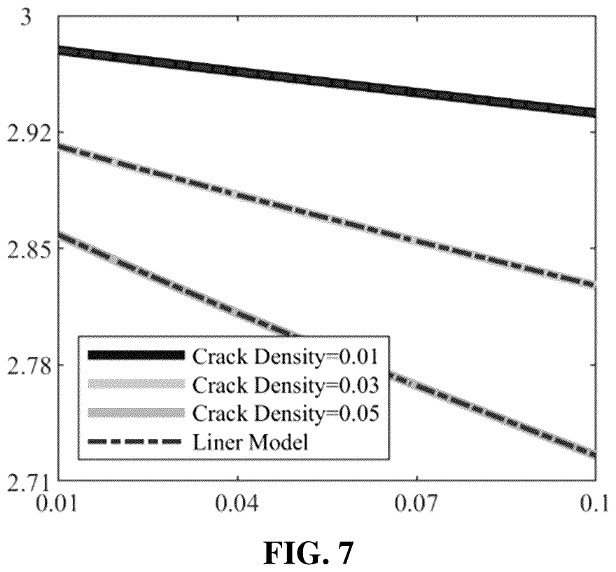

In practical applications, rock physics models exhibit relatively strong nonlinearity, and inversion processes will fall into a local optimum, thereby generating errors. Therefore, the model needs to be linearized. A forward relation formula of the coalbed methane reservoir dual-porosity coal rock physics model is:

$$m \approx f ( x ) + e , \qquad ( 7 )$$

where x is rock physics parameters to be inverted, e is random error, m is the elastic parameters, f(⋅) is a corresponding relationship of the rock physics model. Then, to obtain a linear forward model, first-order Taylor approximation is performed on the above formula at point x₀. That is, the first-order Taylor approximation of the forward relation formula at the point x₀ yields:

$$m \approx f ( {x}_{0} ) + D ( x - {x}_{0} ) , \qquad ( 8 )$$

where D is a linear forward operator of the rock physics model, x is the rock physics parameters to be inverted, m is the elastic parameters, f(⋅) is the corresponding relationship of the rock physics model, and x₀ is a point selected at different independent variables.

$$D = {\vert \frac{\partial f ( {x}_{0} )}{\partial {x}_{0}} \vert}_{x = {x}_{0}} = {\vert \begin{matrix}\frac{\partial {V}_{P}}{\partial {ϕ}_{1}} & \frac{\partial {V}_{P}}{\partial {ϕ}_{2}} & \frac{\partial {V}_{P}}{\partial asp} \\ \frac{\partial {V}_{S}}{\partial {ϕ}_{1}} & \frac{\partial {V}_{S}}{\partial {ϕ}_{2}} & \frac{\partial {V}_{S}}{\partial asp} \\ \frac{\partial ρ}{\partial {ϕ}_{1}} & \frac{\partial ρ}{\partial {ϕ}_{2}} & \frac{\partial ρ}{\partial asp}\end{matrix} \vert}_{x = {x}_{0}} , \qquad ( 9 )$$

where ∂ is a symbol for partial derivative. The effect of model linearization is shown in FIG. 3 to FIG. 8.

Step S140: calculating a matrix porosity, a crack porosity, and a crack aspect ratio of a near-well coalbed methane reservoir based on logging-observed P-wave velocity and S-wave velocity in the well logging data, and taking the matrix porosity, the crack porosity, and the crack aspect ratio of the near-well coalbed methane reservoir as porosity parameter prior information of the deep coalbed methane reservoir dual-porosity coal rock physics model.

In practical applications, the crack aspect ratio is difficult to acquire directly from observed data. Therefore, the matrix porosity and the crack aspect ratio near the well are estimated based on the logging-observed P-wave and S-wave velocities, further providing pore parameter prior information for subsequent inversion, i.e., prior distribution of model parameters obtained from the well logging data.

As an optional embodiment, in step S140, the step of calculating the matrix porosity and the crack aspect ratio near the well based on the logging-observed P-wave velocity and the logging-observed S-wave velocity in the well logging data may specifically include following steps:
solving inversion data using a Bayesian theoretical model, to obtain posterior probability of target parameters with respect to the observed data; determining prior information of a mixed Gaussian distribution using a Gaussian mixture model to describe a prior distribution of physical properties; determining a probability distribution function based on the posterior probability and the prior information; and calculating the matrix porosity and the crack aspect ratio near the well through the probability distribution function based on the logging-observed P-wave velocity and the logging-observed S-wave velocity in the well logging data, to obtain a constructed inversion objective function.

It should be noted that, in Bayesian theory, solving an inversion problem is equivalent to estimating a maximum a posteriori probability. The posterior probability of the target parameters with respect to the observed data is: P(r|m)∝P(m|r)×P(r) (10), where P(r|m) is the posterior probability, P(m|r) is likelihood probability, and P(r) is prior probability.

Next, prior information is obtained using a Gaussian mixture distribution. Statistical characteristic distribution of physical property parameters of rock strata typically exhibits multimodal features, which are difficult to effectively describe using conventional Gaussian distributions or single distribution functions. Therefore, the Gaussian mixture model is adopted to describe the prior distribution of physical properties. The prior information is:

$$P ( r ) = {\sum }_{k = 1}^{C} {φ}_{k} {N}_{k} ( r ; {μ}_{r}^{k} , {Σ}_{r}^{k} ) , \qquad ( 11 )$$

where P(r) is the prior probability, Nₖ represents a k-th Gaussian distribution,

$${μ}_{r}^{k}$$

is an expectation value,

$${Σ}_{r}^{k}$$

is a covariance, φₖ is a weight coefficient, C is a total number of Gaussian distributions, and r represents the prior.

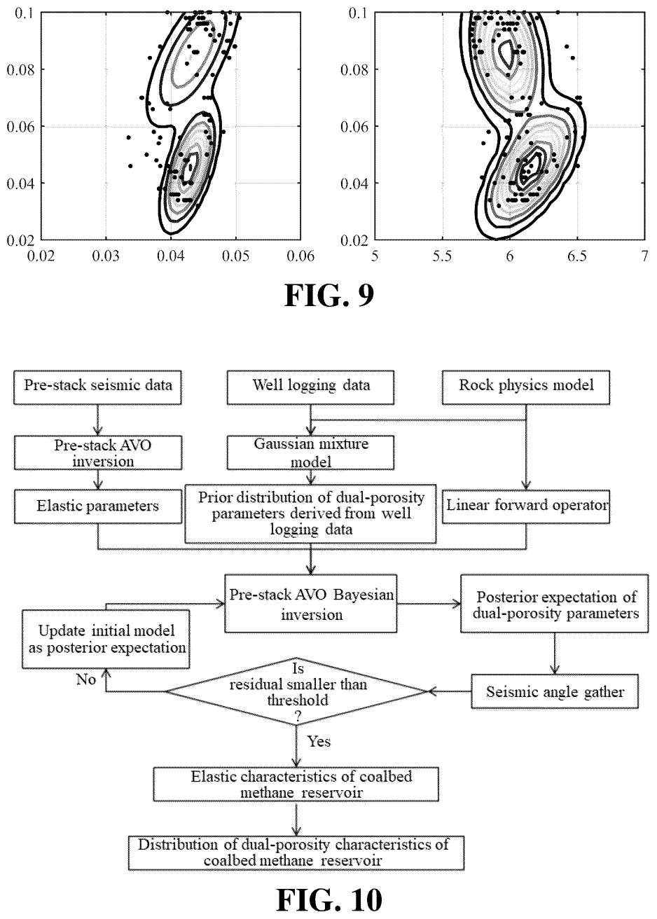

The prior probability distribution of the target parameters is estimated using the maximum expectation algorithm to provide prior expectation and covariance for subsequent Bayesian inversion. Gaussian mixture distributions of the inversion parameters are calculated separately as the prior distribution of the Bayesian inversion. A mixed Gaussian distribution diagram of the well logging data is shown in FIG. 9.

Then, a probability distribution function is acquired. Assuming that random errors in the forward model conform to a standard normal distribution N(e; 0, Σₑ) and that the likelihood probability P(m|r) is determined by a linear model, the posterior probability P(r|m) still conforms to the Gaussian mixture distribution, and the posterior expectation and covariance thereof can be respectively expressed as:

$${μ}_{r \vert m}^{k} = {μ}_{r}^{k} + {Σ}_{r}^{k} {{D}^{T} ( D {Σ}_{r}^{k} {D}^{T} + {Σ}_{e} )}^{- 1} ( m - D {μ}_{r}^{k} ) ; and \qquad ( 12 )$$

$${Σ}_{r \vert m}^{k} = {Σ}_{r}^{k} - {Σ}_{r}^{k} {{D}^{T} ( D {Σ}_{r}^{k} {D}^{T} + {Σ}_{e} )}^{1} D {Σ}_{r}^{k} . \qquad ( 13 )$$

A final inversion result of the target parameters is a weighted mean of the posterior expectation rₑₛₜ:

$${r}_{est} = {\sum }_{k}^{C} {π}^{k} {μ}_{r \vert m}^{k} , \qquad ( 14 )$$

$$where$$

$${π}^{k} ( m ) = \frac{{φ}_{k} N ( m ; D {μ}_{r}^{k} , D {Σ}_{r}^{k} {D}^{T} + {Σ}_{e} )}{{\sum }_{h} {φ}_{h} N ( m ; D {μ}_{r}^{h} , D {Σ}_{r}^{h} {D}^{T} + {Σ}_{e} )} . \qquad ( 15 )$$

Subsequently, an inversion objective function is constructed based on the well logging data. The inversion objective function constructed from the well logging data is:

$$J ( asp ) = {‖ {Vp}_{estimated} - {Vp}_{real} ‖}_{2}^{2} + {‖ {Vs}_{estimated} - {Vs}_{real} ‖}_{2}^{2} ,$$

where asp is a reservoir crack aspect ratio, Vpᵣₑₐₗ and Vsᵣₑₐₗ are the logging-observed P-wave velocity and the logging-observed S-wave velocity in the well logging data (obtained from the well logging data); and Vp_{estimated} and Vs_{estimated} are a model-predicted P-wave velocity and a model-predicted S-wave velocity obtained from the model, being P-wave and S-wave velocities in the vertical direction. A grid search method is adopted to solve formula (14) in the above. A result at minimum of the objective function is taken as the inversion result.

Step S150: performing pre-stack seismic Bayesian inversion using a pre-stack Bayesian inversion method through the coalbed methane reservoir dual-porosity coal rock physics model based on designated three-dimensional seismic horizon data and the porosity parameter prior information, to obtain dual-porosity structure data of the coalbed methane reservoir, and taking the dual-porosity structure data of the coalbed methane reservoir as a dual-porosity structure parameter prediction result of the coalbed methane reservoir.

In the model-driven pre-stack seismic Bayesian inversion process, reflection waveforms of the coalbed methane reservoir are extracted based on three-dimensional seismic horizon interpretation results. Complete dual-porosity structure information of the coal seam is obtained by combining the coalbed methane reservoir rock physics model with the pre-stack Bayesian inversion method.

As an optional embodiment, in the step S150, the step of performing the pre-stack seismic Bayesian inversion using the pre-stack Bayesian inversion method through the coalbed methane reservoir dual-porosity coal rock physics model based on the designated three-dimensional seismic horizon data and the porosity parameter prior information, to obtain dual-porosity structure data of the coalbed methane reservoir, and taking the dual-porosity structure data of the coalbed methane reservoir as the dual-porosity structure parameter prediction result of the coalbed methane reservoir can specifically include following steps:
extracting a pre-stack seismic angle gather based on the designated three-dimensional seismic horizon data to obtain a relationship between reflection-wave time and amplitude under different incident angles at each point; extracting time information of a reflection wave of a target coal seam at each point based on the well logging data and seismic data corresponding to the designated three-dimensional seismic horizon data, and applying a time window along the coal seam to extract reflection-wave information of the target coal seam; obtaining coal component information and water saturation information through interpolation results of the well logging data; constructing a Bayesian inversion objective function of the seismic data based on the time information, the reflection-wave information, the coal component information, the water saturation information, and the relationship between the reflection-wave time and the amplitude; and substituting data of the same angle gather into the Bayesian inversion objective function to perform inversion, to obtain dual-porosity rock physics parameters of the coalbed methane reservoir at a spatial position, and taking the dual-porosity rock physics parameters of the coalbed methane reservoir as dual-porosity structure data of the coalbed methane reservoir.

Exemplarily, the pre-stack seismic angle gather can be first extracted to obtain the relationship between the reflection-wave time and the amplitude at each point under different incidence angles. Time information of the reflection wave of the target coal seam at each point is then obtained by combining the seismic data and the well logging data. Reflection wave information of the target coal seam is extracted by applying the time window along the coal seam. Subsequently, coal component information and water saturation information are obtained based on the interpolation results of the well logging data. A workflow of reservoir dual-porosity structure prediction is shown in FIG. 10.

To simulate seismic response characteristics of underground coal seams, Aki-Richards equation is employed to calculate P-wave reflectivity at different incidence angles:

$$R p p ( θ ) = \frac{1}{2} ( 1 - 4 \frac{{v}_{s}^{2}}{{v}_{p}^{2}} {sin}^{2} Δ θ ) \frac{Δ ρ}{ρ} + \frac{{sec}^{2} Δ θ}{2} \frac{Δ {v}_{p}}{{v}_{p}} - 4 \frac{{v}_{s}^{2}}{{v}_{p}^{2}} {sin}^{2} Δ θ \frac{Δ {v}_{s}}{{v}_{s}} , wherein \qquad ( 18 )$$

$$\{ \begin{matrix}Δ {v}_{p} = {v}_{p 2} - {v}_{p 1} , {v}_{p} = ( {v}_{p 2} + {v}_{p 1} ) / 2 \\ Δ {v}_{p} = {v}_{s 2} - {v}_{s 1} , {v}_{s} = ( {v}_{s 2} + {v}_{s 1} ) / 2 \\ Δ ρ = {ρ}_{2} - {ρ}_{1} , ρ = ( {ρ}_{2} + {ρ}_{1} ) / 2 \\ Δ θ = ( {θ}_{1} + {θ}_{2} ) / 2\end{matrix} , \qquad ( 19 )$$

where vₚ and vₛ are P-wave and S-wave velocities respectively, ρ is density, θ is incidence angle, and subscripts 1 and 2 represent an upper layer interface and a lower layer interface, respectively.

An inversion objective function of the seismic data is then constructed. The Bayesian inversion objective function constructed from the seismic data is:

$$m = arg min {\sum }_{i = 1}^{n} {k}_{i} ( {‖ d - f ( m ) * w ‖}_{2} + {( m - {μ}_{m}^{′} )}^{T} {( {Ω}_{m}^{′} )}^{- 1} ( m - {μ}_{m}^{i} ) ) , \qquad ( 17 )$$

wherein kᵢ is a weight factor of the i-th Gaussian distribution, d is seismic data, m is inversion parameters, f is a mapping relationship, μₘ is an expectation, Ωₘ is a covariance matrix, and w is a seismic wavelet, generally represented by a Ricker wavelet with a fixed functional relationship. The prior Gaussian mixture distribution is derived from the well logging data analysis in second step. Pre-stack seismic inversion is performed based on the inversion objective function constructed from the seismic data. The parameter calculation process in the objective function follows procedures described in formulas (10)~(13) in the above.

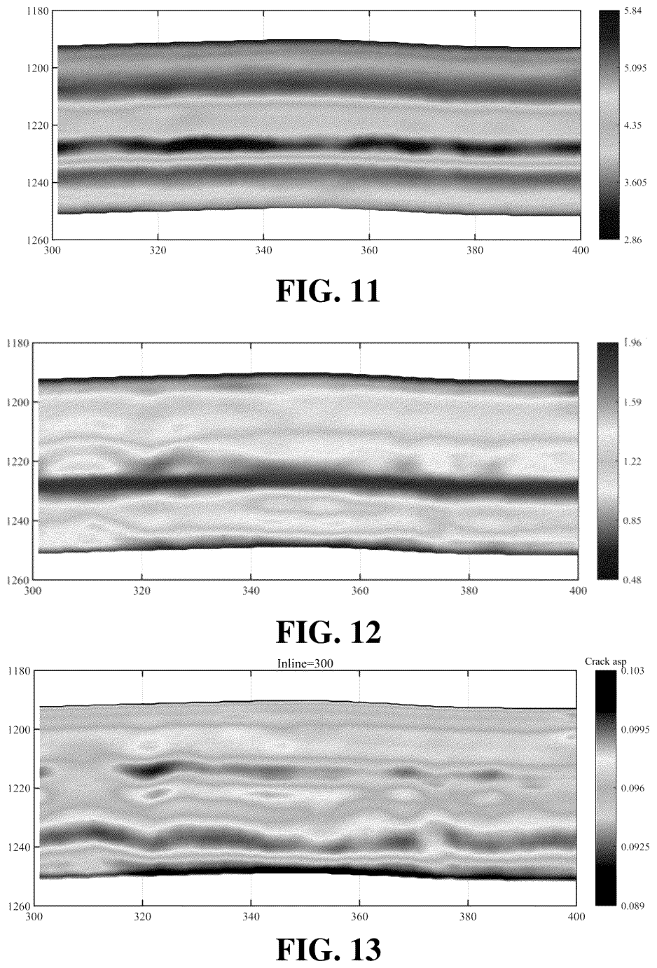

Finally, data from the same angle gather are input into the above formula for inversion, to obtain the dual-porosity rock physics parameters of the coalbed methane reservoir at a spatial location. The prediction effects of the reservoir dual-porosity structure are shown in FIG. 11 to FIG. 13.

In the embodiments of the present disclosure, on the basis of pore structure characteristics of coal rock of the coalbed methane reservoir, a dual-porosity coalbed methane reservoir rock physics model is established. Prior information for Bayesian inversion is determined in combination with the well logging data, and dual-porosity structure parameters of the coalbed methane reservoir are further inverted by combining pre-stack seismic data. This enables full integration of the actual geological characteristics of the coalbed methane reservoir rock. The rock physics model is constructed based on material composition and pore structure characteristics of the coalbed methane reservoir, and linearization is performed by adopting the Taylor series. This improves inversion efficiency, satisfies reservoir prediction analysis using conventional well logging and seismic data, enables prediction of the dual-porosity structure parameters of the coalbed methane reservoir, and further improves the prediction accuracy of the coalbed methane reservoir. Moreover, rock physics modeling serves as a bridge between the microscopic structure and macroscopic properties of rocks, and can quantitatively describe the influence of rock physical parameters, such as pore structure, on the elastic characteristics of rocks. The method of rock physics modeling enables in-depth reconstruction of the pore structure characteristics of the coalbed methane reservoir. A complete elastic matrix is obtained in combination with well logging and seismic data, thereby obtaining accurate dual-porosity structure characteristics of the coalbed methane reservoir. The pore structure in coal is complex and can be regarded as a dual-porosity medium composed of matrix pores and cracks. The rock physics model is employed to describe the dual-porosity characteristics of the deep coalbed methane reservoir, which in turn drives pre-stack AVO inversion of the coalbed methane reservoir, thereby ultimately obtaining the distribution of the dual-porosity structure of the coalbed methane reservoir.

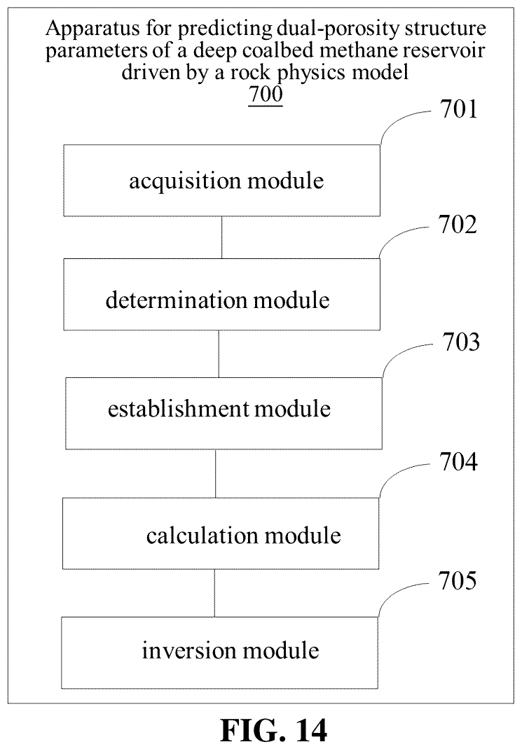

FIG. 14 is a structural schematic diagram of an apparatus for predicting dual-porosity structure parameters of a deep coalbed methane reservoir driven by a rock physics model. As shown in FIG. 14, the apparatus 700 for predicting the dual-porosity structure parameters of the deep coalbed methane reservoir driven by the rock physics model includes:
an acquisition module 701, configured to acquire coal seam mineral data, regional sedimentary background data, and well logging data corresponding to the deep coalbed methane reservoir, and perform simplification processing on mineral components of the coalbed methane reservoir based on the coal seam mineral data and the regional sedimentary background data, to obtain organic matter data, clay data, and brittle mineral data;
a determination module 702, configured to determine an initial clay content using a resistivity extremum method based on the clay data, determine an organic matter content using a resistivity-porosity overlay method based on the organic matter data, and determine a remaining part except the initial clay content and the organic matter content in the mineral components of the deep coalbed methane reservoir as a brittle mineral content, wherein a resistivity corresponding to the resistivity extremum method and a porosity corresponding to the resistivity-porosity overlay method are determined through the well logging data;
an establishment module 703, configured to establish a deep coalbed methane reservoir dual-porosity coal rock physics model using an equivalent medium theory model based on the initial clay content, the organic matter content, and the brittle mineral content;
a calculation module 704, configured to calculate a matrix porosity, a crack porosity, and a crack aspect ratio of a near-well coalbed methane reservoir based on logging-observed P-wave velocity and S-wave velocity in the well logging data, and take the matrix porosity, the crack porosity, and the crack aspect ratio of the near-well coalbed methane reservoir as porosity parameter prior information of the deep coalbed methane reservoir dual-porosity coal rock physics model; and
an inversion module 705, configured to perform pre-stack seismic Bayesian inversion using a pre-stack Bayesian inversion method through the deep coalbed methane reservoir dual-porosity coal rock physics model based on designated three-dimensional seismic horizon data and the porosity parameter prior information, to obtain dual-porosity structure data of the coalbed methane reservoir, and take the dual-porosity structure data of the coalbed methane reservoir as a dual-porosity structure parameter prediction result of the coalbed methane reservoir.

The apparatus for predicting the dual-porosity structure parameters of the deep coalbed methane reservoir driven by the rock physics model provided in the embodiment of the present disclosure has the same technical features as the method for predicting the dual-porosity structure parameters of the deep coalbed methane reservoir driven by the rock physics model described in the above embodiments, and thus can also solve the same technical problems and achieve the same technical effects.

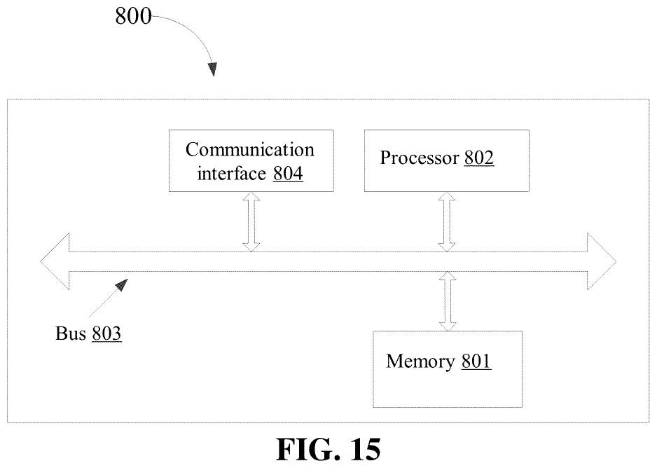

An electronic device provided in an embodiment of the present disclosure is illustrated in FIG. 15. The electronic device 800 includes a processor 802 and a memory 801. The memory 801 stores a computer program executable on the processor, and the processor, when executing the computer program, implements the steps of the method described in the above embodiments.

As shown in FIG. 15, the electronic device further includes a bus 803 and a communication interface 804. The processor 802, the communication interface 804, and the memory 801 are connected through the bus 803. The processor 802 is configured to execute executable modules stored in the memory 801, such as the computer program.

Herein, the memory 801 can include high-speed random access memory (RAM) and can also include non-volatile memory, such as at least one disk memory. The communication connection between the system network element and at least one other network element is achieved through at least one communication interface 804 (which can be wired or wireless), which can use the Internet, WAN, local network, metropolitan network, etc.

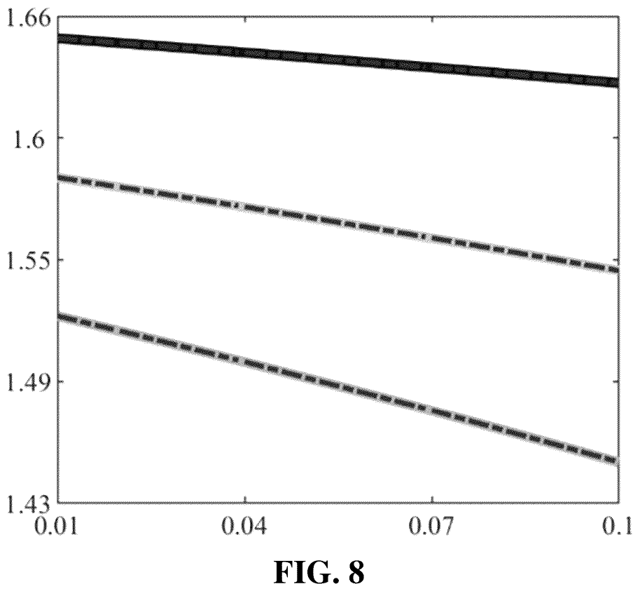

The bus 803 can be an ISA bus, PCI bus, or EISA bus, among others. The bus can be divided into address bus, data bus, control bus, etc. For ease of representation, only one bidirectional arrow is used in FIG. 8, but it does not indicate that there is only one bus or one type of bus.

Herein, the memory 801 is configured to store the program. Upon receiving an execution instruction, the processor 802 executes the program. The method executed by the apparatus defined by the processes disclosed in any of the above embodiments of the present disclosure can be applied in the processor 802 or implemented by the processor 802.

The processor 802 can be an integrated circuit chip with signal processing capability. In the implementation process, various steps of the above method can be accomplished through integrated logic circuits in the hardware of processor 802 or in the form of software instructions. The processor 802 mentioned above can be a general-purpose processor, including a central processing unit (CPU for short), network processor (NP for short), etc. It can also be a digital signal processor (DSP for short), application specific integrated circuit (ASIC for short), field-programmable gate array (FPGA for short), or other programmable logic devices, discrete gates, transistor logic devices, and discrete hardware components. It can implement or perform each of the methods, steps, and logical block diagrams disclosed in the embodiments of the present disclosure. The general-purpose processor can be a microprocessor, or the processor can also be any conventional processor and so on. The steps of the method disclosed in the embodiments of the present disclosure can be directly implemented by execution through a hardware decoder processor or through a combination of hardware and software modules within the decoder processor. The software modules can be located in random access memory, flash memory, read-only memory, programmable read-only memory, electrically erasable programmable memory, registers, or other mature storage media in the field. The storage medium is located in the memory 801, and the processor 802 reads information from the memory 801, and executes the steps of the above method in combination with hardware thereof.

Corresponding to the method for predicting the dual-porosity structure parameters of the deep coalbed methane reservoir driven by the rock physics model described above, an embodiment of the present disclosure further provides a computer-readable storage medium. The computer-readable storage medium stores computer-executable instructions, and when the computer-executable instructions are invoked and executed by a processor, the computer-executable instructions cause the processor to perform the steps of the method for predicting the dual-porosity structure parameters of the deep coalbed methane reservoir driven by the rock physics model described above.

The apparatus for predicting the dual-porosity structure parameters of the deep coalbed methane reservoir driven by the rock physics model provided in the embodiment of the present disclosure may be implemented as specific hardware on a device or as software or firmware installed on the device, etc. The apparatus provided by the embodiment of the present disclosure is implemented with the same principles and produces the same technical effects as the preceding method embodiments. For the sake of descriptive conciseness, reference can be made to the corresponding contents of the preceding method embodiments for parts not mentioned in the apparatus embodiment. It would be clear to those skilled in the art that, for the convenience and brevity of the description, for the specific working processes of the systems, apparatuses, and units described above, reference can be made to the corresponding processes in the preceding method embodiments, which will not be repeated here.

In the embodiments provided in the present disclosure, it should be understood that the apparatus and method disclosed can be implemented in other ways. The above-described embodiments of the apparatus are merely illustrative. For example, the division of the units is only a logical functional division, and there can be other division methods in practical implementation. For another example, multiple units or components can be combined or integrated into another system, or some features can be ignored or not executed. On another point, the mutual coupling or direct coupling or communication connection shown or discussed can be an indirect coupling or communication connection through some communication interfaces, devices or units, which can be in electrical, mechanical, or other forms.

For another example, the flowcharts and block diagrams in the drawings illustrate possible implementations, architectures, functions, and operations of apparatuses, methods, and computer program products according to multiple embodiments of the present disclosure. At this point, each box in the flowcharts or block diagrams can represent a module, program segment, or part of a code. One part of the module, program segment, or code includes one or more executable instructions for implementing the specified logical functions. It should also be noted that in some alternative implementations, the functions indicated in the boxes also may occur in a different order than that indicated in the drawings. For example, two consecutive boxes can actually be executed in parallel, and sometimes they can also be executed in reverse order, depending on the functionality involved. It should also be noted that each box in the block diagrams and/or flowcharts, and the combination of boxes in the block diagrams and/or flowcharts, can be implemented by specialized hardware systems designed to perform the specified functions or actions, or by a combination of specialized hardware and computer instructions.

The units described as separate components may be or may not be physically separated, and the components displayed as units may be or may not be physical units, meaning they can be located in one place or distributed across multiple network units. Some or all of the units can be selected as actually needed to achieve the objectives of the solutions of the embodiments.

Further, in the embodiments of the present disclosure, each functional unit can be integrated into one processing unit, each unit can be physically present separately, or two or more units can be integrated into one unit.

The functionality, when implemented as a software functional unit and sold or used as a stand-alone product, can be stored in a computer-readable storage medium. Based on this understanding, the technical solutions of the present disclosure, in essence, or part that contributes to the prior art, or part of the technical solution, can be embodied in the form of a software product. The computer software product is stored in a storage medium and includes several instructions to enable a computer device (which can be a personal computer, server, network device, etc.) to execute all or some of the steps of the method for predicting the dual-porosity structure parameters of the deep coalbed methane reservoir driven by the rock physics model, described in various embodiments of the present disclosure. The aforementioned storage media include various media that can store program code, such as USB flash drives, portable hard drives, read-only memory (ROM), random access memory (RAM), magnetic disks, or optical discs.

It should be noted that similar numerals and letters indicate similar terms in the following drawings. Therefore, once an item is defined in one drawing, it does not need to be further defined or explained in subsequent drawings. In addition, the terms “first,” “second,” “third” etc. are only used to distinguish the description and should not be construed as indicating or implying relative importance.

Finally, it should be stated that the above-mentioned embodiments are merely specific embodiments of the present disclosure, used to illustrate the technical solutions of the present disclosure, rather than to limit them. The scope of protection of the present disclosure is not limited thereto. Although the present disclosure has been described in detail with reference to the preceding embodiments, those ordinarily skilled in the art should understand that any person skilled in the art could still modify or readily think of changes to the technical solutions described in the preceding embodiments within the technical scope disclosed in the present disclosure, or make equivalent substitutions for some of the technical features; and these modifications, changes, or substitutions do not make the essence of the corresponding technical solutions deviate from the spirit and scope of the technical solutions of the embodiments of the present disclosure, and should be covered within the scope of protection of the present disclosure. Therefore, the scope of protection of the present disclosure should be determined by the scope of protection of the claims.

What is claimed is:

1. A method for predicting dual-porosity structure parameters of a deep coalbed methane reservoir driven by a rock physics model, the method comprising:
acquiring coal seam mineral data, regional sedimentary background data, and well logging data corresponding to the deep coalbed methane reservoir, and performing simplification processing on mineral components of the deep coalbed methane reservoir based on the coal seam mineral data and the regional sedimentary background data, to obtain organic matter data, clay data, and brittle mineral data;
determining an initial clay content using a resistivity extremum method based on the clay data, determining an organic matter content using a resistivity-porosity overlay method based on the organic matter data, and determining a remaining part except the initial clay content and the organic matter content in the mineral components of the deep coalbed methane reservoir as a brittle mineral content, wherein a resistivity corresponding to the resistivity extremum method and a porosity corresponding to the resistivity-porosity overlay method are determined through the well logging data;
establishing a deep coalbed methane reservoir dual-porosity coal rock physics model using an equivalent medium theory model based on the initial clay content, the organic matter content, and the brittle mineral content;
calculating a matrix porosity, a crack porosity, and a crack aspect ratio of a near-well coalbed methane reservoir based on logging-observed P-wave velocity and S-wave velocity in the well logging data, and taking the matrix porosity, the crack porosity, and the crack aspect ratio of the near-well coalbed methane reservoir as porosity parameter prior information of the deep coalbed methane reservoir dual-porosity coal rock physics model; and
performing pre-stack seismic Bayesian inversion processing using a pre-stack Bayesian inversion method through the deep coalbed methane reservoir dual-porosity coal rock physics model based on designated three-dimensional seismic horizon data and the porosity parameter prior information, to obtain dual-porosity structure data of the deep coalbed methane reservoir, and taking the dual-porosity structure data of the deep coalbed methane reservoir as a dual-porosity structure parameter prediction result of the deep coalbed methane reservoir.

2. The method according to claim 1, wherein establishing the deep coalbed methane reservoir dual-porosity coal rock physics model using the equivalent medium theory model based on the initial clay content, the organic matter content, and the brittle mineral content comprises:
performing mixing processing on organic matter, clay, and brittle minerals using a Voigt-Reuss-Hill bounds model based on the initial clay content, the organic matter content, and the brittle mineral content, to obtain elastic parameters of a coal matrix;
constructing dual-porosity characteristics of the deep coalbed methane reservoir, incorporating a dual porosity corresponding to the dual-porosity characteristics of the deep coalbed methane reservoir using a Kuster-Toksoz (KT) model based on the elastic parameters of the coal matrix, simulating a pore fluid bulk modulus under water saturation using an equal-stress averaging formula based on the dual-porosity characteristics of the deep coalbed methane reservoir after incorporating the dual porosity, and introducing a fluid into a dry coal rock dry skeleton of the deep coalbed methane reservoir using a Gassmann equation to simulate an influence result of a pore fluid, to obtain an initial rock physics model; and
performing linearization processing on the initial rock physics model, to obtain the deep coalbed methane reservoir dual-porosity coal rock physics model.

3. The method according to claim 2, wherein the elastic parameters of the coal matrix are obtained through a following formula:
$$\{ \begin{matrix}{M}_{V} = {\sum }_{i = 1}^{N} {M}_{i} \cdot {V}_{i} \\ {M}_{R}^{- 1} = {\sum }_{i = 1}^{N} {M}_{i}^{- 1} \cdot {V}_{i} \\ {M}_{VRH} = \frac{1}{2} ( {M}_{R} + {M}_{V} )\end{matrix} ,$$
wherein Mᵢ is elastic modulus of an i-th brittle mineral, N is total number of the brittle minerals, Vᵢ(i=1, 2, . . . , N) is volume fraction of an i-th substance mineral, M_{VRH} is the elastic parameters of the coal matrix, and M_{V} and M_{R} are intermediate conversion parameters; and
a total pore volume of the deep coalbed methane reservoir corresponding to the dual-porosity characteristics of the deep coalbed methane reservoir comprises following two types of pores: φₜₒₜₐₗ=φ_{stiff}+φ_{crack}, wherein φₜₒₜₐₗ is a total porosity, φ_{stiff} is a porosity of matrix pores, the matrix pores being pores randomly distributed in the coal matrix, φ_{crack} is crack porosity, wherein the crack porosity is randomly arranged;
wherein incorporating the dual porosity corresponding to the dual-porosity characteristics of the deep coalbed methane reservoir using the Kuster-Toksoz (KT) model comprises incorporating the dual porosity into the dual-porosity characteristics of the deep coalbed methane reservoir using the Kuster-Toksoz (KT) model through a following formula:
$$\{ \begin{matrix}{K}_{KT} = \frac{( {K}_{m} + \frac{4}{3} {G}_{m} ) {K}_{m} + \frac{4}{3} {G}_{m} {\sum }_{i = 1}^{N} {f}_{i} ( {K}_{i} - {K}_{m} ) {P}^{m i}}{{K}_{m} + \frac{4}{3} {G}_{m} - {\sum }_{i = 1}^{N} {f}_{i} ( {K}_{i} - {K}_{m} ) {P}^{m i}} \\ {G}_{KT} = \frac{( {G}_{m} + {ζ}_{m} ) {G}_{m} + {\sum }_{i = 1}^{N} {f}_{i} ( {G}_{i} - {G}_{m} ) {Q}^{m i}}{{G}_{m} + {ζ}_{m} - {\sum }_{i = 1}^{N} {f}_{i} ( {G}_{i} - {G}_{m} ) {Q}^{m i}}\end{matrix} ,$$
$$wherein ζ \frac{G}{6} \frac{9 K + 8 G}{K + 2 G} ,$$
wherein Kₘ and Gₘ are bulk modulus and shear modulus of a coal rock matrix, Ki is bulk modulus of an i-th type of pore, fᵢ is volume fraction containing the pores, P^{mi} and Q^{mi} are parameters related to pore shape, K is the bulk modulus, G is the shear modulus, and N is a total number of pores;
wherein simulating the pore fluid bulk modulus under the water saturation using the equal-stress averaging formula based on the dual-porosity characteristics of the deep coalbed methane reservoir after incorporating the dual porosity comprises simulating the pore fluid bulk modulus under the water saturation based on the dual-porosity characteristics of the deep coalbed methane reservoir after incorporating the dual porosity through a following formula:
$$\frac{1}{{K}_{fl}} = \frac{S w}{{K}_{w a t e r}} + \frac{1 - S w}{{K}_{gas}} ,$$
wherein K_{fl} is an equivalent bulk modulus of the pore fluid, K_{water} is a liquid bulk modulus, K_{gas} is an air bulk modulus, and Sw is the water saturation;
wherein introducing the fluid into the dry coal rock dry skeleton of the deep coalbed methane reservoir using the Gassmann equation comprises introducing the fluid into the dry coal rock dry skeleton of the deep coalbed methane reservoir through a following equation:
$${K}_{sat} = \frac{( {ϕ}_{1} + {ϕ}_{2} ) ( \frac{1}{{K}_{0}} - \frac{1}{{K}_{fl}} ) + \frac{1}{{K}_{0}} - \frac{1}{{K}_{dry}}}{( {ϕ}_{1} + {ϕ}_{2} ) ( \frac{1}{{K}_{0}} - \frac{1}{{K}_{fl}} ) \frac{1}{{K}_{d}} + ( \frac{1}{{K}_{0}} - \frac{1}{{K}_{dry}} ) \frac{1}{{K}_{0}^{2}}} ,$$
wherein φ₁ and φ₂ are porosities of matrix pores and cracks respectively, K₀ is a bulk modulus of rock minerals, K_{dry} is a bulk modulus of a dry rock skeleton, K_{fl} is a fluid bulk modulus, and K_{d} is a bulk modulus of a dry coal rock skeleton; and
a forward relation formula of the deep coalbed methane reservoir dual-porosity coal rock physics model is:
$$m \approx f ( x ) + e ,$$
wherein x is rock physics parameters to be inverted, e is random error, m is the elastic parameters, f(⋅) is a corresponding relationship of the rock physics model; and performing first-order Taylor approximation on the forward relation formula at a point x₀ yields:
$$m \approx f ( {x}_{0} ) + D ( x - {x}_{0} ) ,$$
wherein D is a linear forward operator of the rock physics model, x is the rock physics parameters to be inverted, m is the elastic parameters, f(⋅) is the corresponding relationship of the rock physics model, and x₀ is a point selected at different independent variables.

4. The method according to claim 1, wherein calculating the matrix porosity and the crack aspect ratio of the near-well coalbed methane reservoir based on the logging-observed P-wave velocity and S-wave velocity in the well logging data comprises:
solving inversion data using a Bayesian theoretical model, to obtain posterior probability of target parameters with respect to observed data;
determining prior information of a mixed Gaussian distribution using a Gaussian mixture model to describe a prior distribution of physical properties;
determining a probability distribution function based on the posterior probability and the prior information; and
calculating the matrix porosity and the crack aspect ratio of the near-well coalbed methane reservoir through the probability distribution function based on the logging-observed P-wave velocity and logging-observed S-wave velocity in the well logging data, to obtain a constructed inversion objective function.

5. The method according to claim 4, wherein the posterior probability of the target parameters with respect to the observed data is:
$$P ( r \vert m ) ∝ P ( m \vert r ) \times P ( r ) ,$$
wherein P(r|m) is the posterior probability, P(m|r) is a likelihood probability, and P(r) is a prior probability;
the prior information is:
$$P ( r ) = {\sum }_{k = 1}^{C} {φ}_{k} {N}_{k} ( r ; {μ}_{r}^{k} , {\sum }_{r}^{k} ) ,$$
wherein P(r) is the prior probability, Nₖ represents a k-th Gaussian distribution,
$${μ}_{r}^{k}$$
is an expectation value of the k-th Gaussian distribution,
$${\sum }_{r}^{k}$$
is a covariance of the k-th Gaussian distribution, φₖ is a weight coefficient of the k-th Gaussian distribution, C is a total number of Gaussian distributions, and r represents prior; and
the inversion objective function is:
$$J ( a s p ) = {‖ {Vp}_{e s t i m a t e d} - V {p}_{r e a l} ‖}_{2}^{2} + {‖ {Vs}_{e s t i m a t e d} - V {s}_{r e a l} ‖}_{2}^{2} ,$$
wherein asp is the crack aspect ratio of the deep coalbed methane reservoir, Vpᵣₑₐₗ and Vsᵣₑₐₗ are the logging-observed P-wave velocity and the logging-observed S-wave velocity in the well logging data; and Vp_{estimated} and Vs_{estimated} are a model-predicted P-wave velocity and a model-predicted S-wave velocity, respectively.

6. The method according to claim 1, wherein performing the pre-stack seismic Bayesian inversion processing using the pre-stack Bayesian inversion method through the deep coalbed methane reservoir dual-porosity coal rock physics model based on the designated three-dimensional seismic horizon data and the porosity parameter prior information, to obtain the dual-porosity structure data of the deep coalbed methane reservoir, and taking the dual-porosity structure data of the deep coalbed methane reservoir as the dual-porosity structure parameter prediction result of the deep coalbed methane reservoir comprises:
extracting a pre-stack seismic angle gather based on the designated three-dimensional seismic horizon data to obtain a relationship between reflection-wave time and amplitude under different incident angles at each point;
extracting time information of a reflection wave of a target coal seam at each point based on the well logging data and seismic data corresponding to the designated three-dimensional seismic horizon data, and applying a time window along the target coal seam to extract reflection-wave information of the target coal seam;
obtaining coal component information and water saturation information through interpolation results of the well logging data;
constructing a Bayesian inversion objective function of the seismic data based on the time information, the reflection-wave information, the coal component information, the water saturation information, and the relationship between the reflection-wave time and the amplitude; and
substituting data of a same angle gather into the Bayesian inversion objective function to perform inversion, to obtain dual-porosity rock physics parameters of the deep coalbed methane reservoir at a spatial position, and taking the dual-porosity rock physics parameters of the deep coalbed methane reservoir as the dual-porosity structure data of the deep coalbed methane reservoir.

7. The method according to claim 6, wherein the Bayesian inversion objective function is:
$$m = arg min {\sum }_{i = 1}^{n} {k}_{i} ( {‖ d - f ( m ) * w ‖}_{2} + {( m - {μ}_{m}^{i} )}^{T} {( {Ω}_{m}^{i} )}^{- 1} ( m - {μ}_{m}^{i} ) ) ,$$
wherein kᵢ is a weight factor of an i-th Gaussian distribution, d is the seismic data, m is inversion parameters, f is a mapping relationship, μₘ is an expectation, Ωₘ is a covariance matrix, and w is a seismic wavelet.

8. An apparatus for predicting dual-porosity structure parameters of a deep coalbed methane reservoir driven by a rock physics model, the apparatus comprising:
an acquisition module configured to acquire coal seam mineral data, regional sedimentary background data, and well logging data corresponding to the deep coalbed methane reservoir, and perform simplification processing on mineral components of the deep coalbed methane reservoir based on the coal seam mineral data and the regional sedimentary background data, to obtain organic matter data, clay data, and brittle mineral data;
a determination module configured to determine an initial clay content using a resistivity extremum method based on the clay data, determine an organic matter content using a resistivity-porosity overlay method based on the organic matter data, and determine a remaining part except the initial clay content and the organic matter content in the mineral components of the deep coalbed methane reservoir as a brittle mineral content, wherein a resistivity corresponding to the resistivity extremum method and a porosity corresponding to the resistivity-porosity overlay method are determined through the well logging data;
an establishment module configured to establish a deep coalbed methane reservoir dual-porosity coal rock physics model using an equivalent medium theory model based on the initial clay content, the organic matter content, and the brittle mineral content;
a calculation module configured to calculate a matrix porosity, a crack porosity, and a crack aspect ratio of a near-well coalbed methane reservoir based on logging-observed P-wave velocity and S-wave velocity in the well logging data, and take the matrix porosity, the crack porosity, and the crack aspect ratio of the near-well coalbed methane reservoir as porosity parameter prior information of the deep coalbed methane reservoir dual-porosity coal rock physics model; and
an inversion module configured to perform pre-stack seismic Bayesian inversion processing using a pre-stack Bayesian inversion method through the deep coalbed methane reservoir dual-porosity coal rock physics model based on designated three-dimensional seismic horizon data and the porosity parameter prior information, to obtain dual-porosity structure data of the deep coalbed methane reservoir, and take the dual-porosity structure data of the deep coalbed methane reservoir as a dual-porosity structure parameter prediction result of the deep coalbed methane reservoir.

9. An electronic device comprising a memory and a processor, wherein the memory stores a computer program executable on the processor, and the processor, upon executing the computer program, implements the method according to claim 1.

10. A non-transitory computer-readable storage medium, wherein the non-transitory computer-readable storage medium stores computer-executable instructions, and the computer-executable instructions, upon being invoked and executed by a processor, cause the processor to run the method according to claim 1.
